(19) United States
(12) Patent Application Publication
(10) Pub. No.: US 2010/0328440 A1
(43) Pub. Date: Dec. 30, 2010

(54) AUTOSTEREOSCOPIC DISPLAY DEVICE

(75) Inventor: Oscar Hendrikus Willemsen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/865,473

(22) PCT Filed: Feb. 2, 2009
(86) PCT No.: PCT/IB2009/050395

§ 371 Date: Jul. 30, 2010

(30) Foreign Application Priority Data
Feb. 8, 2008 (EP) 08151189.1

(51) Int. Cl. H04N 13/04

(52) U.S. Cl. 348/59; 348/51; 348/E13.075

(57) ABSTRACT

An autostereoscopic display device having a plurality of operating modes for providing different brightness non-uniformity and cross talk display characteristics. The device comprises: an image forming means having an array of display pixels for producing a display, the display pixels being spatially defined by an opaque matrix; and a view forming means arranged in registration with the image forming means and having an array of view forming elements configurable to focus outputs of groups of the display pixels into a plurality of views projected towards a user in different directions, thereby enabling autostereoscopic imaging, wherein a focusing strength of the view forming means is electrically switchable. The device also comprises a driving means arranged to drive the image forming means with video data for the plurality of views and to switch the focusing strength of the view forming means between first and second values substantially corresponding to local minima of an intensity modulation depth introduced by imaging of the opaque matrix.

### FIELD OF THE INVENTION

This invention relates to an autostereoscopic display device comprising an image forming means, such as a display panel having an array of display pixels, and a view forming means. The view forming means may be an array of lenticular lenses arranged over the image forming element through which the display pixels are viewed. The invention also relates to a method of driving an autostereoscopic display device.

### BACKGROUND OF THE INVENTION

A known autostereoscopic display device is described in GB 2196166 A. This known device comprises a two dimensional emissive liquid crystal display panel having a row and column array of display pixels acting as an image forming means to produce a display. An array of elongate lenticular lenses extending parallel to one another overlies the display pixel array and acts as a view forming means. Outputs from the display pixels are projected through these lenticular lenses, which function to modify the directions of the outputs.

The lenticular lenses are provided as a sheet of elements, each of which comprises an elongate semi-cylindrical lens element. The lenticular lenses extend in the column direction of the display panel, with each lenticular lens overlying a respective group of two or more adjacent columns of display pixels.

In an arrangement in which, for example, each lenticular lens is associated with two columns of display pixels, the display pixels in each column provide a vertical slice of a respective two dimensional sub-image. The lenticular sheet projects these two slices and corresponding slices from the display pixel columns associated with the other lenticular lenses, to the left and right eyes of a user positioned in front of the sheet, so that the user observes a single stereoscopic image.

In other arrangements, each lenticular lens is associated with a group of three or more adjacent display pixels in the row direction. Corresponding columns of display pixels in each group are arranged appropriately to provide a vertical slice from a respective two dimensional sub-image. As a user's head is moved from left to right a series of successive, different, stereoscopic views are observed creating, for example, a look-around impression.

The above described autostereoscopic display device produces a display having good levels of brightness. However, a problem associated with the device is that the views projected by the lenticular sheet are separated by dark zones caused by “imaging” of the non-emitting black matrix which typically defines the display pixel array. These dark zones are readily observed by a user as brightness non-uniformities in the form of dark vertical bands spaced across the display. The bands move across the display as the user moves from left to right and the pitch of the bands changes as the user moves towards or away from the display.

A number of approaches have been proposed for reducing the amplitude of the non-uniformities. For example, the amplitude of the non-uniformities can be reduced by the well known technique of slanting the lenticular lenses at an acute angle relative to the column direction of the display pixel array. However, it remains difficult to reduce the intensity modulation depth introduced by imaging the black matrix to below 1%, at which level the non-uniformities remain perceivable and distracting for a user.

Another approach for reducing the amplitude of the non-uniformities is the so-called fractional view arrangement, which is described in detail in WO 2006/117707 A2. Devices having a fractional view arrangement are characterized in that the pitch of the slanted lenticular lenses is not equal to an integer number times the pitch of the display pixels (i.e. the sub-pixel pitch in a color display), and in that the pixels under successive lenticular lenses are positioned in a horizontally alternating fashion. As a result, the successive lenses simultaneously project different amounts of the black matrix, leading to intensity modulations which are mutually shifted in phase. The first harmonic of the total intensity cancels out, leaving a much less intense non-uniformity effect. According to this approach, the intensity modulation depth introduced by imaging the black matrix may be reduced to well below 1%.

It has been found that the intensity modulation depth introduced by imaging the black matrix in the above described devices also varies as a function of the focusing power of the lenticular lenses. In general, defocusing the lenses in a device by increasing their focal length causes a reduction in the intensity modulation depth introduced by imaging the black matrix. However, defocusing the lenses also gives rise to cross-talk between the views projected by the lenticular sheet, which is detrimental to the three dimensional effect perceived by the user.

### SUMMARY OF THE INVENTION

According to a first aspect of the invention, there is provided an autostereoscopic display device comprising:

an image forming means having an array of display pixels for producing a display, the display pixels being spatially defined by an opaque matrix;

a view forming means arranged in registration with the image forming means and having an array of view forming elements configurable to focus outputs of groups of the display pixels into a plurality of views projected towards a user in different directions, thereby enabling autostereoscopic imaging, wherein a focusing strength of the view forming means is electrically switchable; and

a driving means arranged to drive the image forming means with video data for the plurality of views and to switch the focusing strength of the view forming means between first and second values substantially corresponding to local minima of an intensity modulation depth introduced by imaging of the opaque matrix.

It has been found that the relationship between the focusing strength of the view forming means and the intensity modulation depth introduced by imaging the black matrix is non-linear, with the modulation depth exhibiting successively smaller local minima as the focusing strength is reduced (for example, by increasing the focal length of lens elements defining the view forming means). By switching the focusing strength of the view forming means between values corresponding to these local minima, a plurality of display modes may be provided, each mode providing a different intensity modulation depth introduced by imaging of the opaque matrix and a different amount of cross talk between the views.

In particular, the device may provide first and second display modes in which the focusing strengths of the view forming means are switched to the first and second values, respectively.

In the first mode, the focusing strength of the view forming means is switched to a first value corresponding to a first local minima of the intensity modulation depth, which focusing strength is close to (but slightly lower than) the focusing strength at which the focal plane of the view forming means coincides with the plane of the display pixel array. This first mode may provide low cross talk between the views at the expense of a relatively high intensity modulation depth.

In the second mode, the focusing strength of the view forming means is switched to a second, lower value (for example, by increasing the focal length of lens elements defining the view forming means) corresponding to a second (lower) local minima of the intensity modulation depth. This second mode may provide a lower intensity modulation depth at the expense of higher cross talk between the views.

The first mode may be suitable where very good three dimensional performance is required, for example in advertising applications or in video sequences having a large amount of “depth”. The second mode may be suitable where image quality is more important, for example in video sequences having a small amount of “depth” or in stationary images.

The image forming means may be a liquid crystal display panel comprising a backlight for producing an emissive display.

The array of view forming elements may be configurable to function as a barrier layer having an array of transmissive slits, in which case the focusing strength is switched by altering the width of the slits.

Alternatively, the view forming means may take the form of an array of elements capable of functioning as lenses for modifying the direction of outputs from the display pixels, with electrically switchable focusing strength.

For example, in a first group of embodiments, the view forming means comprises a plurality of view forming units arranged in series, at least one of the view forming units comprising an electro-optic material, such as an oriented liquid crystal material, formed as an array of lenticular elements between transparent substrates having electrode layers. One of the substrates is profiled to provide the lenticular form of the electro-optic material.

A refractive index of the electro-optic material is switchable by selective application of an electric field to maintain or remove a light output direction modifying function of the unit. The driving means is then arranged to switch the focusing strength of the view forming means by selectively applying the electric field to the electro-optic material of the view forming unit.

The driving means may be arranged to switch the focusing strength of the view forming means by changing a selected one of the view forming units for which the light output direction modifying function is maintained, and/or by changing a number of the view forming units for which the light output direction modifying function is maintained simultaneously. In the latter case, the focusing strength of the view forming means is defined by the combined effect of the view forming units.

The driving means may be further arranged to provide a two dimensional mode of operation by maintaining the light output direction modifying function of none of the view forming units, so that light passes through the entire view forming mean without any modification to its direction. In this case, the driving means is arranged to drive the image forming means with conventional video data for a single view.

In a second group of embodiments, the view forming means comprises a view forming unit and a switchable light diffuser arranged in series, wherein the view forming unit is configured or configurable to function as an array of lenses for modifying the direction of outputs from the display pixels, wherein the switchable light diffuser is arranged to selectably perform a beam spreading function, and wherein the driving means is arranged to switch the focusing strength of the view forming means by selectively activating the beam spreading function of the switchable light diffuser.

In a third group of embodiments, the view forming means comprises an electro-optic material, such as an oriented liquid crystal material, disposed between transparent substrates having electrode layers, at least one of the electrode layers comprising an array of individually addressable electrodes for applying an electric field across the electro-optic material to induce a lens-functioning orientation. The driving means is then arranged to switch the focusing strength of the view forming means by selectively providing an electrical potential to the individually addressable electrodes. Lenses defined by such an arrangement are known as so-called graded index (GRIN) lenses.

The driving means may be arranged to switch the focusing strength of the view forming means by selectively providing the electrical potential to different ones of the individually addressable electrodes such that a distance between adjacent electrodes having the electrical potential is changed.

The driving means may be further arranged to provide a two dimensional mode of operation by providing the electrical potential to none or all of the individually addressable electrodes.

In some embodiments of the autostereoscopic display device, the view forming means is configurable to function as an array of elongate lenticular lenses arranged at an acute angle to a column direction of the display pixels, that is to say so-called slanted lenticular lenses.

In this case, the autostereoscopic display device may additionally have the so-called fractional view arrangement, as described in WO 2006/117707 A2. Such an arrangement is characterized in that the central axes of the elongate lenticular lenses and the centre lines of the display pixels in the column direction at their crossing at least for a part of the display define cross sections, the positions of the cross sections at a particular centre line being determined by position numbers denoting the positions relative to a first cross section at the centre line in units of the display pixel pitch in the first direction, each of the position numbers being the sum of a positive or negative integer number and a fractional position number having a number larger than or equal to zero and smaller than one, all cross sections at the particular centre line being distributed in a number of k sets, each set having a factional position number in the range 0, 1/k, 2/k, . . . , (k−1)/k for k>0, the contribution of the different sets of fractional parts to the total number of fractional parts for the centre line being substantially equal. The value of k may, for example, be 2, 3 or 4.

In embodiments of the autostereoscopic display device, the driving means is arranged to temporally vary the focusing strength of the view forming means; that is to say the focusing strength of the view forming means would vary from frame to frame for a sequence of video.

Alternatively or additionally, the driving means may be arranged to spatially vary the focusing strength of the view forming means, that is to say the focusing strength of the view forming means would vary within each frame for a sequence of video data.

The driving means may further comprise means for receiving and decoding a component of video data indicative of a focusing strength of the view forming means with which the video data is to be displayed. In this case, the focusing strength of the view forming means is determined according to a dedicated component of the video data and may have been set in advance.

Alternatively, the driving means may further comprises means for analyzing video data and determining a focusing strength of the view forming means with which the video data is to be displayed based on the analysis. In this case, the focusing strength of the view forming means is dynamically determined based on the content, such as a depth map component of the data.

Of course, the focusing strength of the view forming means may alternatively be determined simply by manual selection by the user based on viewing preferences.

According to another aspect of the invention, there is provided a method of operating an autostereoscopic display device, the device comprising:

an image forming means having an array of display pixels for producing a display, the display pixels being spatially defined by an opaque matrix; and

a view forming means arranged in registration with the image forming means and having an array of view forming elements configurable to focus outputs of groups of the display pixels into a plurality of views projected towards a user in different directions, thereby enabling autostereoscopic imaging, wherein a focusing strength of the view forming means is electrically switchable,

wherein the method comprises:

driving the image forming means with first video data for the plurality of views and simultaneously controlling the focusing strength of the view forming means to be a first value substantially corresponding to a first local minima of an intensity modulation depth introduced by imaging of the opaque matrix; and

driving the image forming means with second video data for the plurality of views and simultaneously controlling the focusing strength of the view forming means to be a second value substantially corresponding to a second local minima of an intensity modulation depth introduced by imaging of the opaque matrix.

According to yet another aspect of the invention, there is provided a method of analyzing video data for an autostereoscopic display device, the device comprising:

an image forming means having an array of display pixels for producing a display, the display pixels being spatially defined by an opaque matrix; and

a view forming means arranged in registration with the image forming means and having an array of view forming elements configurable to focus outputs of groups of the display pixels into a plurality of views projected towards a user in different directions, thereby enabling autostereoscopic imaging, wherein a focusing strength of the view forming means is electrically switchable,

the method comprising analyzing video data and determining a focusing strength of the view forming means with which the video data is to be displayed based on the analysis.

The invention also provides a computer program comprising computer program code means adapted to perform all the steps of the above described method when said program is run on a computer. The invention may be in the form of a computer program product for performing the steps of the method of the invention.

### BRIEF DESCRIPTION OF THE DRAWINGS

Embodiments of the invention will now be described, purely by way of example, with reference to the accompanying drawings, in which:

FIG. 1 is a schematic perspective view of a known autostereoscopic display device;

FIG. 2 is a schematic cross sectional view of the display device shown in FIG. 1;

FIGS. 3a, 3b and 3c are diagrams for explaining the operation of another known autostereoscopic display device;

FIG. 4 is a graph showing the simulated intensity of brightness non-uniformities plotted against lens radius for two known autostereoscopic display devices;

FIG. 5 is a schematic perspective view of an autostereoscopic display device according to the invention;

FIG. 6 is a schematic cross sectional view of an element of the display device shown in FIG. 5;

FIGS. 7a and 7b are diagrams for explaining the operation of element shown in FIG. 6;

FIGS. 8a and 8b are schematic cross sectional views for explaining the operation of an alternative arrangement for the element shown in FIG. 6; and

FIG. 9 is a schematic cross sectional view of an alternative arrangement for the element shown in FIGS. 8a and 8b.

### DETAILED DESCRIPTION OF EMBODIMENTS

The invention provides a multi-view autostereoscopic display device of the type that has an image forming means and a view forming means. The device also has a driving means arranged to drive the image forming means with video data for the plurality of views.

The image forming means has an array of display pixels for producing a display, with the display pixels being spatially defined by an opaque matrix.

The view forming means is arranged in registration with the image forming means and has an array of view forming elements configurable to focus outputs of groups of the display pixels into a plurality of views projected towards a user in different directions. A focusing strength of the view forming means is electrically switchable.

The driving means is additionally arranged to switch the focusing strength of the view forming means between first and second values substantially corresponding to local minima of an intensity modulation depth introduced by imaging of the opaque matrix. In this way, different three dimensional display modes are provided.

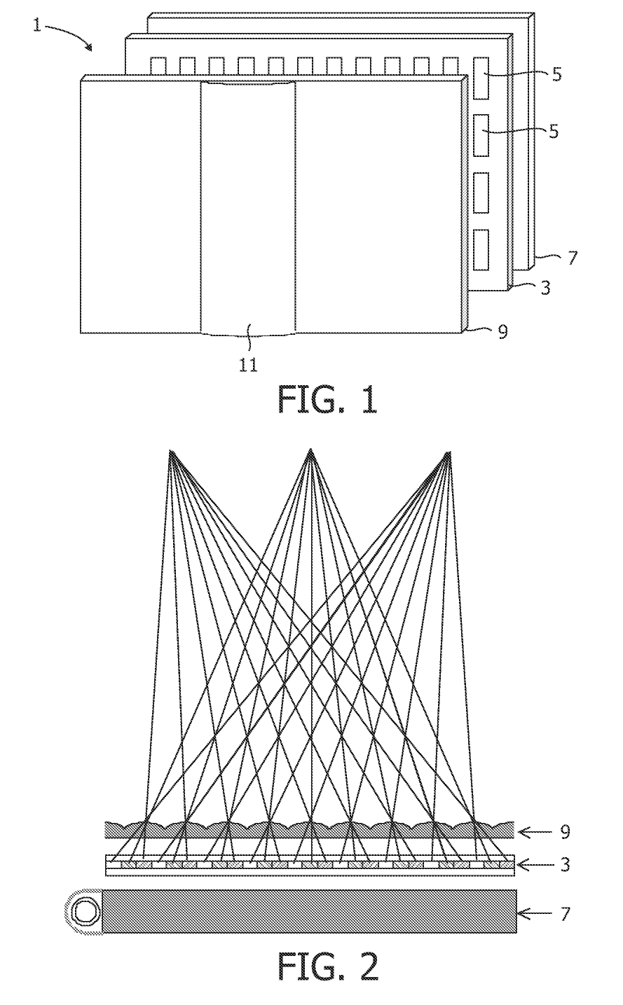

FIG. 1 is a schematic perspective view of a known multi-view autostereoscopic display device 1. The known device 1 comprises a liquid crystal display panel 3 of the active matrix type that acts as an image forming means to produce the display.

The display panel 3 has an orthogonal array of display pixels 5 arranged in rows and columns. For the sake of clarity, only a small number of display pixels 5 are shown in the Figure. In practice, the display panel 3 might comprise about one thousand rows and several thousand columns of display pixels 5.

The structure of the liquid crystal display panel 3 is entirely conventional. In particular, the panel 3 comprises a pair of spaced transparent glass substrates, between which an aligned twisted nematic or other liquid crystal material is provided. The substrates carry patterns of transparent indium tin oxide (ITO) electrodes on their facing surfaces. Polarizing layers are also provided on the outer surfaces of the substrates.

Each display pixel 5 comprises opposing electrodes on the substrates, with the intervening liquid crystal material therebetween. The shape and layout of the display pixels 5 are determined by the shape and layout of the electrodes and a black matrix arrangement provided on the front of the panel 3. The display pixels 5 are regularly spaced from one another by gaps.

Each display pixel 5 is associated with a switching element, such as a thin film transistor (TFT) or thin film diode (TFD). The display pixels are operated to produce the display by providing addressing signals to the switching elements, and suitable addressing schemes will be known to those skilled in the art.

The display panel 3 is illuminated by a light source 7 comprising, in this case, a planar backlight extending over the area of the display pixel array. Light from the light source 7 is directed through the display panel 3, with the individual display pixels 5 being driven to modulate the light and produce the display.

The display device 1 also comprises a lenticular sheet 9, arranged over the display side of the display panel 3, which performs a view forming function. The lenticular sheet 9 comprises a row of lenticular lenses 11 extending parallel to one another, of which only one is shown with exaggerated dimensions for the sake of clarity. The lenticular lenses 11 act as view forming elements to perform a view forming function.

The lenticular lenses 11 are in the form of convex cylindrical elements, and they act as a light output directing means to provide different images, or views, from the display panel 3 to the eyes of a user positioned in front of the display device 1.

The autostereoscopic display device 1 shown in FIG. 1 is capable of providing several different perspective views in different directions. In particular, each lenticular lens 11 overlies a small group of display pixels 5 in each row. The lenticular element 11 projects each display pixel 5 of a group in a different direction, so as to form the several different views. As the user's head moves from left to right, his/her eyes will receive different ones of the several views, in turn.

FIG. 2 shows the principle of operation of a lenticular type imaging arrangement as described above and shows the light source 7, display panel 3 and the lenticular sheet 9. The arrangement provides three views each projected in different directions. Each pixel of the display panel 3 is driven with information for one specific view.

The above described autostereoscopic display device produces a display having good levels of brightness. However, a problem associated with the device is that the views projected by the lenticular sheet are separated by dark zones caused by imaging of the non-emitting black matrix which typically defines the display pixel array. These dark zones are readily observed by a user as brightness non-uniformities in the form of dark vertical bands spaced across the display. The bands move across the display as the user moves from left to right and the pitch of the bands changes as the user moves towards or away from the display. The bands are particularly problematic in devices having a high proportion of their display area as black matrix, such as high resolution displays designed for mobile applications.

A number of approaches have been proposed for reducing the amplitude of the non-uniformities. For example, the amplitude of the non-uniformities can be reduced by the well known technique of slanting the lenticular lenses at an acute angle relative to the column direction of the display pixel array. However, it remains difficult to reduce the intensity modulation depth introduced by imaging the black matrix to below 1%, at which level the non-uniformities remain perceivable and distracting for a user.

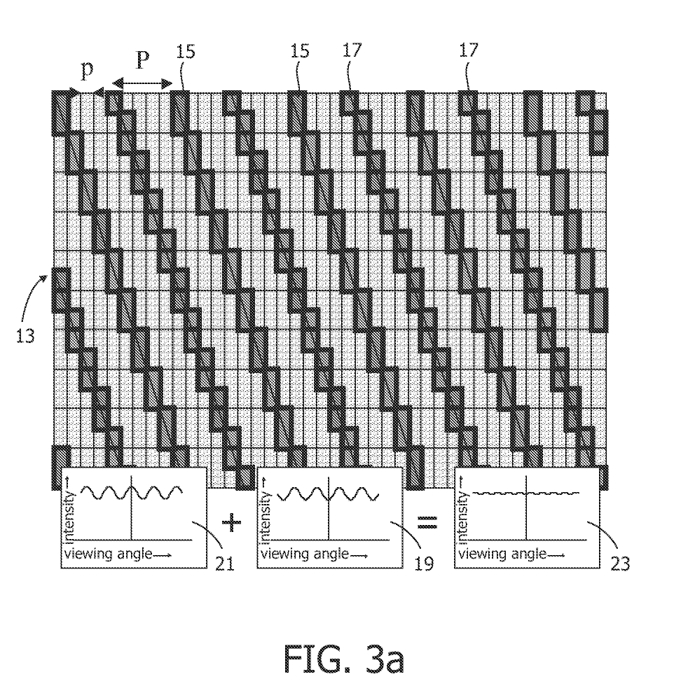

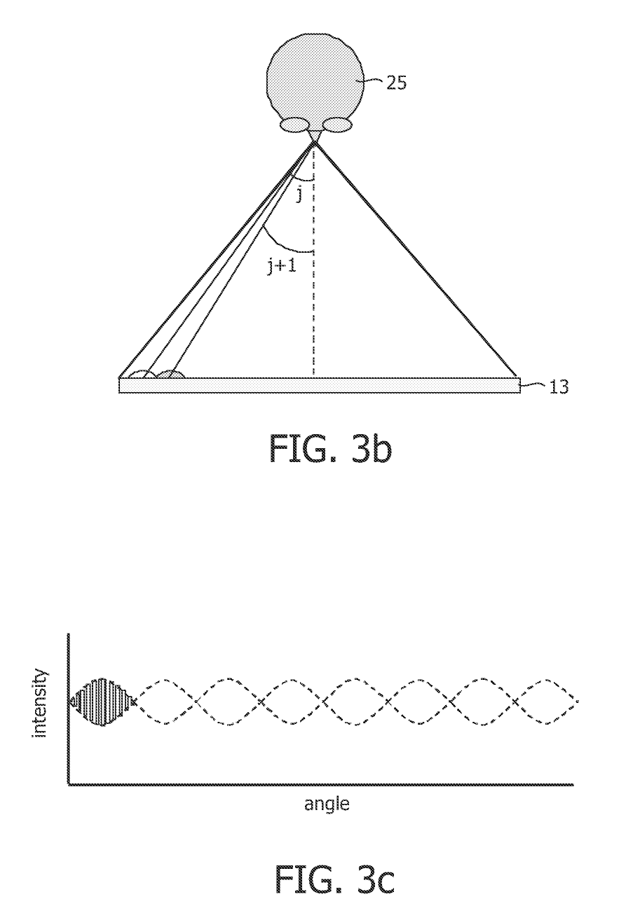

Another approach for reducing the amplitude of the non-uniformities is the so-called fractional view arrangement, which is described in detail in WO 2006/117707 A2. An autostereoscopic display device having a fractional view arrangement will now be described with reference to FIGS. 3a, 3b and 3c.

Devices having a fractional view arrangement are characterized in that the pitch P of the slanted lenticular lenses is not equal to an integer number times the pitch p of the display pixels (i.e. the sub-pixel pitch in a color display), and in that the pixels under successive lenticular lenses are positioned in a horizontally alternating fashion.

In FIG. 3a, a display device having a “4.5 view” arrangement is shown in which the pitch P of the lenticular lenses is equal to 4.5 times the pixel (or sub-pixel) pitch p. For such a display, two classes of lenses can be identified.

A first class of the lenses, known as “odd” lenses and identified in the Fig. by their slanted lens axes 15, are characterized by the centers of the pixels being spaced from the lens axis by a distance of (n×p), where n is an integer. A second class of the lenses, known as “even” lenses and identified in the Fig. by their slanted lens axes 17, are characterized by the centers of the pixels being spaced from the lens axis by a distance of ((n+0.5)×p), where n is an integer.

The two classes of lenses 15, 17 give rise to respective intensity distributions 19, 21, as shown in the Figure, each having a modulation depth that is very similar to that of a conventional autostereoscopic display device with slanted lenticular lenses (not having a fractional view arrangement). The intensity distributions 19, 21 differ from each other in that the angles at which maxima and minima occur is interchanged so that their phases are mutually offset. As a result, the first harmonic of the total intensity cancels out, leaving a much less intense non-uniformity effect, illustrated as intensity distribution 23 in FIG. 3a.

The way in which a user observes the fractional view arrangement shown in FIG. 3a will now be explained with specific reference to FIGS. 3b and 3c.

FIG. 3b is a schematic plan view of the user 25 observing the display device 13. In practice, when the user 25 observes the display device from left to right, he scans an angle such that the individual lenticular lenses are observed at different angles (j, j+1, . . . ). The first lens observed by the user is an even-type lens 17, which is observed at angle j and with intensity A(j). The second lens observed by the user is an odd-type lens 15, which is observed at angle (j+1) and with intensity B(j+1). Thus, the sequence of intensities observed by the user is A(j), B(j+1), A(j+2), B(j+3), . . . .

The intensities observed by the user are plotted against viewing angle in FIG. 3c. This Fig. shows a high frequency modulation with a modulation equal to the modulation depth of the individual contributions. This modulation is known as the lens-to-lens modulation, which tends to be less noticeable that the above described brightness non-uniformities, since it occurs on a much smaller scale.

Furthermore, the modulation shown in FIG. 3c has an average value equal to the summed intensity distribution 23 shown in FIG. 3a. This summed intensity distribution 23 has a higher spatial frequency and, more significantly, a lower modulation depth that those of the separate intensity distributions 19, 21 shown in FIG. 3a.

For the purposes of this invention, a fractional view arrangement is defined in line with WO 2006/117707 as one in which the central axes of the elongate lenticular lenses and the centre lines of the display pixels in the column direction at their crossing at least for a part of the display define cross sections, the positions of the cross sections at a particular centre line being determined by position numbers denoting the positions relative to a first cross section at the centre line in units of the display pixel pitch in the first direction, each of the position numbers being the sum of a positive or negative integer number and a fractional position number having a number larger than or equal to zero and smaller than one, all cross sections at the particular centre line being distributed in a number of k sets, each set having a fractional position number in the range 0, 1/k, 2/k, . . . , (k−1)/k for k>0, the contribution of the different sets of fractional parts to the total number of fractional parts for the centre line being substantially equal. The value of k may, for example, be 2, 3 or 4.

Although the techniques of slanting the lenticular lenses and providing a fractional view arrangement may serve to reduce the perceived brightness non-uniformities caused by imaging of the black matrix, further significant reductions may be advantageously be achieved by defocusing the lenticular lenses. These further reductions, however, come at the expense of introducing cross talk between the views, which is detrimental to the perceived three dimensional performance of a device. This cross talk generally increases as the lenticular lenses are defocused.

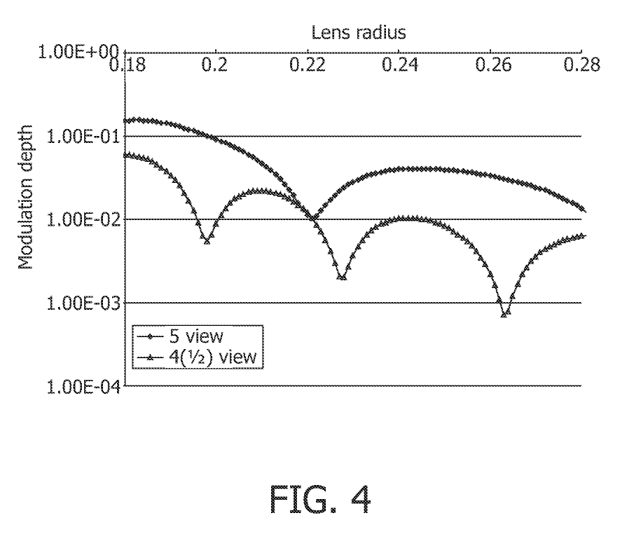

FIG. 4 is a graph showing the simulated intensity modulation depth caused by imaging of the black matrix plotted against lens radius for two known autostereoscopic display devices. Lens radius is used here as a measure of focusing strength (lens radius and focusing strength have an inverse relationship). The values plotted in the Fig. were obtained by performing a numerical simulation by ray tracing through the lenticular geometry.

The first know device for which intensity modulation depth is plotted in FIG. 4 is a “5 view” device with lenticular lenses having a slant angle of arctan (⅓). The second know device for which intensity modulation is plotted in FIG. 4 is the “4.5 view” device having the fractional view arrangement described above with reference to FIGS. 3a to 3b.

For both devices, a lens radius of 183 microns provides a focal plane which coincides with the plane of the display pixel array (i.e. perfect focus). At this lens radius, intensity modulation depth is a maximum. As the lenses are defocused by increasing the lens radius (and thereby reducing the focusing strength), the intensity modulation depth reduces and is characterized by an series of reducing local minima.

For example, for the “4.5 view” device, these local minima correspond to lens radii of 198 microns, 228 microns and 263 microns. Of these lens radii, 198 microns is closest to the lens radius for which the focal plane coincides with the plane of the display pixel array, and therefore provides the least amount of cross talk between views. The lens radius of 263 microns provides the lowest intensity modulation depth, but at the expense of greater cross talk. The lens-to-lens modulation is also different for the three lens radii.

It will accordingly be seen that, in selecting a lens radius for the device, there is a trade off between the desirable properties of low intensity modulation depth and low cross talk between the views.

The invention recognizes this trade off, and also recognizes the fact that lens radii corresponding to different ones of the local minima are appropriate for different display applications. For example, in the “4.5 view” device, a lens radius of 198 microns may be appropriate if good three dimensional performance is required (i.e. low cross talk), for example in advertising applications or in video sequences having a large amount of “depth”. On the other hand, a lens radius of 263 microns may be appropriate if image quality is more important (i.e. low intensity modulation depth), for example in video sequences having a small amount of “depth” or in stationary images.

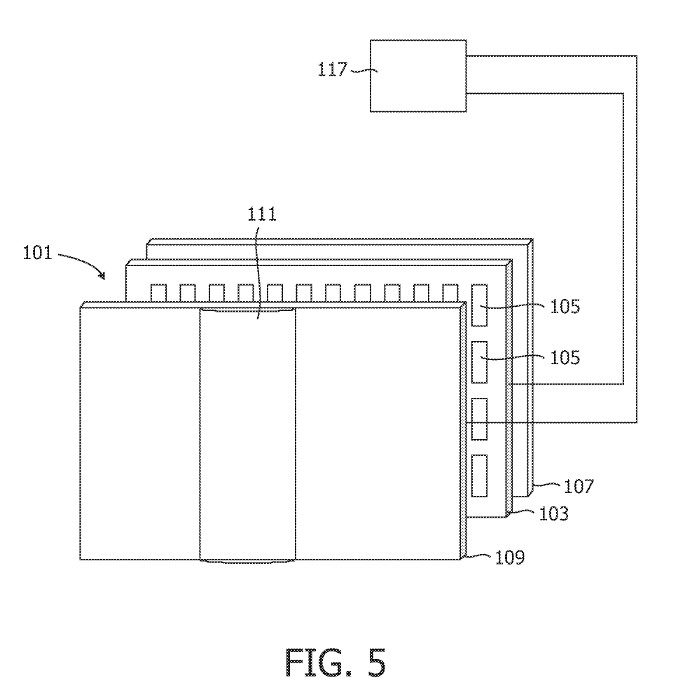

Accordingly, the invention provides an autostereoscopic display device in which the focusing strength of the view forming means is switchable between values corresponding to the above described local minima, thereby providing display modes suitable for different applications. A device according to the invention will now be described with reference to FIG. 5.

With reference to the Figure, the autostereoscopic display device 101 according to the invention is similar in general structure to the known device 1 shown in FIGS. 1 and 2. Thus, the device 101 comprises a display panel 103 performing an image forming function, a light source 107 for the display panel 103, and a lenticular sheet 109 performing a view forming function. The display panel 103 and the light source 107 in particular are identical to those described above with reference to FIG. 1.

The device 101 according to the invention differs from the device shown in FIGS. 1 and 2 in that lenticular lenses 111 of the lenticular sheet 109 have an electrically switchable focusing strength (or effective lens radius). This allows for the device to be switched between different display modes corresponding to the intensity modulation depth local minima. Although not shown in the Fig. for clarity reasons, the lenticular lenses 111 are slanted at an acute angle relative to the column direction of the display panel 103 and have the fractional view arrangement described with reference to FIGS. 3a, 3b and 3c.

Furthermore, the device 101 according to the invention comprises a driving means 117 arranged both for driving the display panel 103 with video data for the views and for driving the lenticular lenses 111 having the switchable focusing strength, as will be explained below.

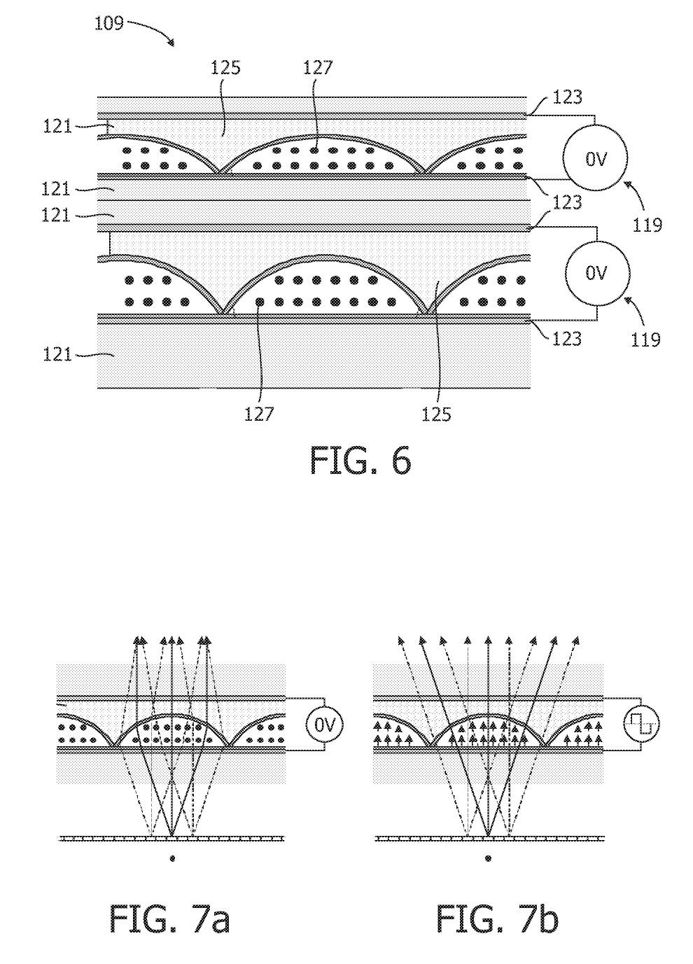

The lenticular sheet 109 having lenses 111 with switchable focusing power will now be described in greater detail. Referring to FIG. 6, the lenticular sheet 109 comprises a pair of view forming units 119 arranged in series and each covering the entire area of the display panel 103.

Each unit 119 comprises a pair of glass plates 121, the facing surfaces of which are provided with transparent electrodes 123 formed of indium tin oxide (ITO). A lens structure 125 formed, for example, by a known replication technique is provided between the glass plates 121. The lens structures 125 of the units 119 have different lens radii.

Within each unit 119, the surface of the lens structure 125 and the surface of one of the glass plates 121 which define a space therebetween are provided with an orientation layer formed of polyimide (not shown). The space is filled with a liquid crystal material 127 which aligns under the influence of the polyimide layers and which has a refractive index which alters under the influence of an electric field.

In use of the lenticular sheet 109, the driving means 117 is used to selectively applies a voltage across the electrodes 123 of each of the view forming units 119. In a first driving state of each unit, the refractive index of the liquid crystal material 127 matches that of the lens structure 125 and the unit 199 has no or negligible overall effect on the direction of transmitted light. This state is shown, for one of the units 119, in FIG. 7b.

In a second driving state of each unit, the refractive index of the liquid crystal material 127 is higher than that of the lens structure 125 and the unit 199 then functions as an array of lenses to modify the direction of transmitted light. This state is shown, for one of the units 119, in FIG. 7a.

For producing a three dimensional display, the view forming units 119 are driven so that one of the units 119 is in the first driving state (providing no lens function) and the other of the units 119 is in the second driving state (providing a lens function). Since the lens structures 125 of the units 119 have different lens radii, selection of the unit 119 having the first driving state serves to select a particular lens radius (i.e. focusing strength). In this example, the lens radii of the view forming units 119 may provide the appropriate focusing strength for display modes corresponding to the first and local minima shown in FIG. 4.

The driving means 117 of the device 101 is also arranged to provide a two dimensional mode of operation. This mode is obtained by driving both of the view forming units 119 with the first driving state, so that neither provides any lens function. In this mode, the display panel 103 may be driven with ordinary two dimensional video data which is displayed with maximum resolution.

The structure and operation of arrangements suitable for use as the view forming units 119 shown in FIGS. 6, 7a and 7b is described in greater detail in U.S. Pat. No. 6,069,650.

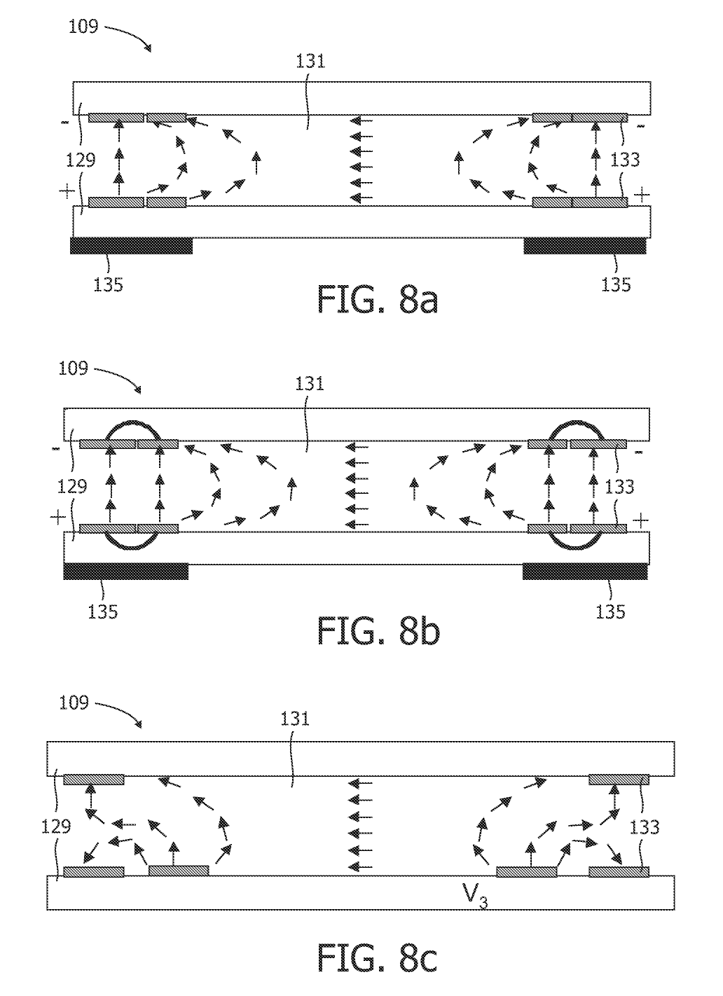

FIGS. 8a and 8b show an alternative arrangement for the lenticular sheet 109 of device 101 according to the invention. This alternative arrangement employs so-called graded index (GRIN) lenses, the structure and general operation of which are described in WO 2007/072330 A1.

The alternative arrangement comprises a liquid crystal cell formed of a liquid crystal material 131 sandwiched between a pair of glass plates 129 having electrode layers 133 on their facing surfaces.

The electrode layers 133 have individually addressable transparent electrode structures formed, for example, of indium tin oxide (ITO). The surfaces of the glass plates 129 which define a space therebetween are also provided with an orientation layer formed of polyimide (not shown) for orientating the liquid crystal material 131.

In use of the alternative arrangement, the driving means 117 is used to apply a voltage across selected ones of the electrodes 133. In the presence of the resulting electric field, the liquid crystal molecules assume the orientations shown in FIGS. 8a and 8b. Light transmitted by the arrangement passes through regions of the liquid crystal material 131 having different refractive indices such that the arrangement provides a lens function.

The relatively small area of liquid crystal material 131 positioned directly between the electrode structures 133 to which the voltage is applied does not provide a lens function, i.e. there is no graded index, and this area is masked by a mask layer 135 formed on one of the glass plates 129, as shown in the Figures.

The lens function of the arrangement shown in FIGS. 8a and 8b is approximated by the following equation:

$$f = \frac{{P}^{2}}{8 d ( {n}_{e} - {n}_{0} )}$$

where f is the focal distance of the lenses, P is the pitch of the lens, d is the cell gap and nₑ, and nₒ are the extraordinary and ordinary indices of refraction, respectively.

Based on the above formula, it can be seen that focusing strength can be varied by altering the effective pitch of the lenses. This can be achieved by effectively widening the electrode area across which a voltage is applied, so that the distance therebetween is reduced.

In FIGS. 8a and 8b, an electrode pattern 133 consisting of four electrodes arranged in pairs is provided on each glass plate 129. FIG. 8a shows the orientation of the liquid crystal material 131 when a voltage is applied using one of the electrodes in each pair, specifically the left or right hand side electrode in each pair. In this case, the lens has a relatively large effective pitch and therefore a relatively large focal length, as defined by the above equation. FIG. 8b shows the orientation of the liquid crystal material 131 when a voltage is applied using both of the electrodes in each pair. In this case, the lens has a smaller effective pitch and therefore a smaller focal length, as defined by the above equation.

By selectively applying the voltage across different ones of the individually addressable electrodes 133, arrangements having different focusing strengths can be obtained for providing different three dimensional display modes.

A two dimensional display mode may also be obtained by completely removing the voltage from the electrode structures, so that the arrangement provides no lens function for transmitted light.

FIG. 9 is a schematic cross sectional view of an alternative arrangement. In this arrangement, one of the electrodes defining each lens is provided with an additional, different voltage, V₃, which is greater than the voltages applied to the other electrodes. In this way, the electric field distribution between the electrodes formed on the facing glass plates 129 can be disturbed such that a masking layer 135 is not required. Suitable electrode sizes, positions and voltages may be determined for a particular arrangement by experimentation.

A preferred embodiment of the invention has been described above. However, it will be understood by those skilled in the art that various changes and modifications may be made without departing from the scope of the invention.

For example, three arrangements for lenticular sheets having switchable focusing strengths have been described, but other arrangements are possible. In particular, a lenticular sheet having switchable focusing strength may have one of the following implementations:

(i) Two view forming units each providing a switchable lens function, arranged in series as shown in FIG. 6. The units may function as lenses having different lens radii, as described above, or may alternatively function as lenses having the same lens radii, in which case the defocusing effect (or focusing strength) they each provide will vary in dependence on their separation from the focal plane.
(ii) One view forming unit providing a fixed lens function and one view forming unit providing a switchable lens function, arranged in series. In this case, the fixed unit alone might provide sufficient focusing strength for one display mode, with the switchable unit selectably providing additional focusing strength for another display mode.
(iii) One view forming unit providing a fixed lens function and a switchable light diffusion element, arranged in series. In this case, the fixed unit alone might provide sufficient focusing strength for one display mode, with the switchable diffusion element selectably providing a defocusing or beam spreading function. Switchable light diffusion elements will be known to persons skilled in the art.
(iv) One view forming unit providing a switchable lens function and a switchable light diffusion element, arranged in series.
(v) A graded index (GRIN) lens arrangement, such as the ones shown in FIGS. 8a, 8b and 9.

It is envisaged that lenticular sheets may additionally be implemented by other means, for example by employing on an electrically switchable difference in the refractive index of materials of a liquid crystal cell.

The above described lenticular sheets comprise liquid crystal cells. However, other electro-optic materials may be used, provided their refractive index can be varied by application of an electric field or other external influence.

The above described device according to the invention provides two and three dimensional display modes. In the two dimensional mode, a lenticular sheet provides no view forming function. In other embodiments of the invention, such as those embodied using view forming units having a fixed lens function, there may only be provided three dimensional modes of operation.

All of the view forming means described above are implemented using lenticular sheets which function as an array of lenses. The invention is also applicable to devices in which the view forming means comprises a barrier layer provided with an array of spaced apart light transmissive slits, which type of devices will be well known to persons skilled in the art. In these devices, the switchable focusing strength may be provided according to the invention by varying the width of the light transmissive slits, for example by implementing the barrier layer as an array of switchable transmissive liquid crystal cells.

The driving means may drive the view forming means such that focusing strength varies spatially (i.e. over the display area) or temporally (i.e. from frame to frame). This may be in response to user selection, a specific component of the video data being displayed, or real time analysis of the content of the video data.

The display and method of the invention have the advantage that by changing the depth performance of the display will be adjusted according to the content displayed. Hence, the content may be given a parameter that codes for the depth and which is varied spatially over the display area and/or in time in order to attract attention of a viewer. Hence, the display and method may be useful in e.g. warning systems, or signage purposes.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim enumerating several means, several of these means may be embodied by one and the same item of hardware. The mere fact that certain measures are recited in mutually different dependent claims does not indicate that the combination of these measures cannot be used to advantage.

1. An autostereoscopic display device comprising:
an image forming means (103) having an array of display pixels (105) for producing a display, the display pixels being spatially defined by an opaque matrix;
a view forming means (109) arranged in registration with the image forming means (103) and having an array of view forming elements (111) configurable to focus outputs of groups of the display pixels (105) into a plurality of views projected towards a user in different directions, thereby enabling autostereoscopic imaging, wherein a focusing strength of the view forming means (109) is electrically switchable; and
a driving means (117) arranged to drive the image forming means (103) with video data for the plurality of views and to switch the focusing strength of the view forming means (109) between first and second values substantially corresponding to local minima of an intensity modulation depth introduced by imaging of the opaque matrix.

2. An autostereoscopic display device according to claim 1, wherein the array of view forming elements (111) is configurable to function as a barrier layer having an array of transmissive slits.

3. An autostereoscopic display device according to claim 1, wherein the array of view forming elements (111) is configurable to function as an array of lenses for modifying the direction of outputs from the display pixels.

4. An autostereoscopic display device according to claim 3, wherein the view forming means (109) comprises a plurality of view forming units (119) arranged in series, at least one of the view forming units comprising an electro-optic material (127) formed as an array of lenticular elements between transparent substrates (121) having electrode layers (123), a refractive index of the electro-optic material being switchable by selective application of an electric field to maintain or remove a light output direction modifying function of the unit (119), and wherein the driving means (117) is arranged to switch the focusing strength of the view forming means (109) by selectively applying the electric field to the electro-optic material (127) of the view forming unit (119).

5. An autostereoscopic display device according to claim 3, wherein the view forming means (109) comprises a view forming unit and a switchable light diffuser arranged in series, wherein the view forming unit is configured or configurable to function as an array of lenses for modifying the direction of outputs from the display pixels, wherein the switchable light diffuser is arranged to selectably perform a beam spreading function, and wherein the driving means (117) is arranged to switch the focusing strength of the view forming means (109) by selectively activating the beam spreading function of the switchable light diffuser.

6. An autostereoscopic display device according to claim 3, wherein the view forming means (109) comprises an electro-optic material (131) disposed between transparent substrates (129) having electrode layers (133), at least one of the electrode layers comprising an array of individually addressable electrodes for applying an electric field across the electro-optic material (131) to induce a lens-functioning orientation, and wherein the driving means (117) is arranged to switch the focusing strength of the view forming means (109) by selectively providing an electrical potential to the individually addressable electrodes.

7. An autostereoscopic display device according to claim 1, wherein the driving means (117) is further arranged to provide a two dimensional mode of operation.

8. An autostereoscopic display device according to claim 1, wherein the view forming means (109) is configurable to function as an array of elongate view forming elements (111) arranged at an acute angle to a column direction of the display pixels (105).

9. An autostereoscopic display device according to claim 8, wherein the central axes of the elongate view forming elements (111) and the centre lines of the display pixels (105) in the column direction at their crossing at least for a part of the display define cross sections, the positions of the cross sections at a particular centre line being determined by position numbers denoting the positions relative to a first cross section at the centre line in units of the display pixel pitch in the first direction, each of the position numbers being the sum of a positive or negative integer number and a fractional position number having a number larger than or equal to zero and smaller than one, all cross sections at the particular centre line being distributed in a number of k sets, each set having a factional position number in the range 0, 1/k, 2/k, . . . , (k−1)/k for k>0, the contribution of the different sets of fractional parts to the total number of fractional parts for the centre line being substantially equal.

10. An autostereoscopic display device according to claim 1, wherein the driving means (117) is arranged to temporally and/or spatially vary the focusing strength of the view forming means (109).

11. An autostereoscopic display device according to claim 1, wherein the driving means (117) further comprises means for receiving and decoding a component of video data indicative of a focusing strength of the view forming means with which the video data is to be displayed.

12. An autostereoscopic display device according to claim 1, wherein the driving means (117) further comprises means for analyzing video data and determining a focusing strength of the view forming means (109) with which the video data is to be displayed based on the analysis.

13. A method of operating an autostereoscopic display device, the device comprising:
an image forming means (103) having an array of display pixels (105) for producing a display, the display pixels being spatially defined by an opaque matrix; and
a view forming means (109) arranged in registration with the image forming means (103) and having an array of view forming elements (111) configurable to focus outputs of groups of the display pixels (105) into a plurality of views projected towards a user in different directions, thereby enabling autostereoscopic imaging, wherein a focusing strength of the view forming means (109) is electrically switchable,
wherein the method comprises:
driving the image forming means (103) with first video data for the plurality of views and simultaneously controlling the focusing strength of the view forming means (109) to be a first value substantially corresponding to a first local minima of an intensity modulation depth introduced by imaging of the opaque matrix; and
driving the image forming means (103) with second video data for the plurality of views and simultaneously controlling the focusing strength of the view forming means (109) to be a second value substantially corresponding to a second local minima of an intensity modulation depth introduced by imaging of the opaque matrix.

14. A method of analyzing video data for an autostereoscopic display device, the device comprising:
an image forming means (103) having an array of display pixels (105) for producing a display, the display pixels being spatially defined by an opaque matrix; and
a view forming means (109) arranged in registration with the image forming means (103) and having an array of view forming elements (111) configurable to focus outputs of groups of the display pixels (105) into a plurality of views projected towards a user in different directions, thereby enabling autostereoscopic imaging, wherein a focusing strength of the view forming means (109) is electrically switchable,
the method comprising analyzing video data and determining a focusing strength for the view forming means (109) with which the video data is to be displayed based on the analysis.

15. A computer program comprising computer program code means adapted to perform all the steps of claim 13 when said program is run on a computer.
